(19) United States
(12) Patent Application Publication
(10) Pub. No.: US 2009/0261958 A1
(43) Pub. Date: Oct. 22, 2009

(54) LOW COST, AUTOMATIC COLLISION NOTIFICATION SYSTEM AND METHOD OF USING THE SAME

(76) Inventors: Srinivasan Sundararajan, Ann Arbor, MI (US); Stephen William Rouhana, Plymouth, MI (US)

Correspondence Address: RADER, FISHMAN & GRAUER PLLC;FORD GLOBAL TECHNOLOGIES, INC., 39533 WOODARD AVENUE, SUITE #140, BLOOMFIELD HILLS, MI, 48304, US

(21) Appl. No.: 12/103,817

(22) Filed: Apr. 16, 2008

(51) Int. Cl. B60Q 1/00; H04M 11/04

(52) U.S. Cl. 340/436; 455/404.1

(57) ABSTRACT

The present invention is directed to a low cost, automatic, vehicle collision notification system and method of initiation a low cost automatic vehicle collision notification. The system comprises an electronic controller with a buffer memory wherein resides information related to vehicle direction, speed, and restraint conditions; at least one vehicle crash sensor electronically connected to said electronic controller to produce data signals indicative of a vehicular crash at least one vehicle speed sensor electronically connected to said electronic controller to produce data signals indicative of actual vehicle speed and a cellular telephone chip electronically connected to said electronic controller the chip may be configured to automatically communicate directly with a PSAP/911 emergency call center as a native, local, high priority call when a vehicle crash is detected by the electronic control unit. The cellular chip may be capable of transmitting information from the electronic control unit buffer directly to a PSAP/911 emergency call center to facilitate the dispatch of assistance to the vehicle. The method includes operating a vehicle with an electronic controller receiving data signals indicative of vehicle speed, vehicle direction, restraint condition and storing it on rewritable memory in a buffer determining whether said vehicle is in a crash situation activating the cellular chip and placing a 911 telephone call and, initiating communication with said 911 emergency center and transferring information in said buffer to said 911 emergency center as a high priority call.

### TECHNICAL FIELD

The present invention is directed to a low cost, automatic, vehicle collision notification system and method of initiating a low cost automatic vehicle collision notification to a local Public Safety Answering Point (PSAP), commonly known as 911 emergency centers, as a high priority telephone call. In some current automatic collision systems, if an airbag is deployed in the event of a crash, the vehicle places a telephone call to the telematic service provider (TSP). The operator at the TSP then talks to the vehicle driver to assess the situation. If, in the operator's view, the situation warrants further assistance, the operator determines the nearest 911 emergency call center and places a telephone call to that 911 emergency center, usually with a regular 10 digit telephone number, and provides the 911 center with the vehicle location and other details, if available.

Some limitations of such a system are that there is a significant delay in communicating vital accident location and other information to the Public Safety Answering Point (PSAP), commonly known as the 911 emergency center, thereby causing a delay in providing much needed assistance. In addition, such systems may require a subscription fee from the owner, or the system may not operate, and finally, the TSP 10 digit call has a much lower priority status to a PSAP/911 emergency call center than a regular 911 emergency telephone call.

There is a need for a low cost, automatic vehicle collision notification system that provides high priority telephone calls, i.e., a native 911 emergency telephone call to a PSAP/911 emergency call center, and a method of effecting such a system, without the need for a subscription fee or delay by interposing an operator between the driver or other vehicle occupant involved in a vehicle collision and a PSAP/911 emergency call center.

### SUMMARY OF THE INVENTION

In one aspect, the present invention is directed to a low cost, automatic, vehicle collision notification system. The system may be comprised of an electronic controller with a buffer memory (ECU), preferably a rewritable memory, wherein resides information related to vehicle direction, speed, and restraint conditions, etc. At least one vehicle crash sensor is electronically connected to the electronic controller to produce data signals indicative of a vehicular crash. The system further includes at least one vehicle speed sensor electronically connected to the electronic controller to produce data signals indicative of actual vehicle speed and a cellular telephone chip electronically connected to the electronic controller. The chip is configured to automatically communicate directly with a local PSAP/911 emergency center as a high priority call when a vehicle crash is detected by said electronic controller. The cellular chip is capable of transmitting information from the electronic controller buffer directly to the PSAP/911 emergency call center to facilitate the dispatch of assistance to the vehicle.

The vehicle crash sensors may be selected from at least one of an accelerometer, airbag sensor, a restraint sensor, a seat belt buckle sensor, or a vehicle occupant sensor, and the system may include a Global Positioning System (GPS) to provide vehicle location information to the memory buffer. Other systems include an e911 enabled cellular chip that can provide location data. The cellular chip may further include direct two way voice communication with the PSAP/911 emergency call center over a speaker in the event a vehicle crash is detected. Because the telephone communication with the local PSAP/911 emergency call center is direct, it receives a high priority from the PSAP/911 emergency call center.

In another aspect, the present invention relates to a method to facilitate a low cost, automatic vehicle collision notification to a PSAP/emergency 911 call center as a high priority local call. The method consists of the steps of operating a vehicle with an electronic controller receiving data signals indicative of vehicle speed, vehicle direction, restraint condition and storing it on rewritable memory in a buffer determining whether the vehicle is in a crash situation activating the cellular chip and placing a direct 911 telephone call and initiating communication with the vehicle and transferring information in said buffer directly to the PSAP/911 emergency call center as a high priority call.

The method further includes transferring data from the electronic controller buffer directly to the PSAP/911 emergency call center. The transferring of data may be automatic or voice activated, and any voice communication may be two way. The method may further include automatically notifying local police agencies that a vehicle crash situation may exist as well as data indicative of vehicle location and vehicle direction, as well as restraint conditions on the vehicle. The method may also include transmission of data to a database which can be accessed by emergency responders, dispatchers, trauma centers, or other authorized organizations.

The data in the buffer may include, but is not limited to, vehicle location, such as by a compass or compass module electronically connected to the ECU to transmit signals to the ECU indicative of vehicle location and direction of travel, vehicle speed, or whether the vehicle is in a crash situation by including data signals from sensors such as accelerometers, air bag sensors, vehicle restraint sensors, pre-crash sensors, such as, for example, radar and vision based collision avoidance warning systems, seat belt buckle sensors and occupant sensors, to name a few.

These and other objects may be understood by a reading of the specification, claims and drawings.

### BRIEF DESCRIPTION OF THE DRAWINGS

FIG. 1 is a schematic representation of one embodiment of a system according to the present invention.

FIG. 2 is a representation of a software flow chart of one method according to one embodiment of the present invention.

### DETAILED DESCRIPTION OF THE PREFERRED EMBODIMENT(S)

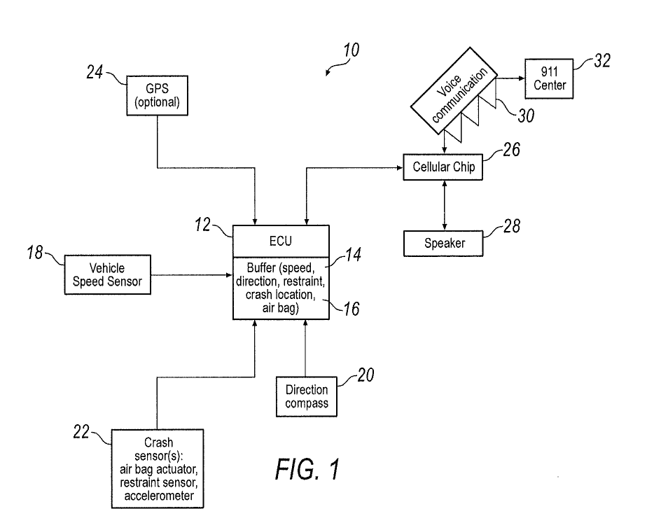

Turning now to the drawings wherein like numbers refer to like structures, FIG. 1 is a schematic representation of one system according to the present invention. System 10 is comprised of electronic control unit (ECU) 12, having a buffer 14 with memory 16. The memory may be volatile or non volatile, and may be PROM, EPROM, EEPROM or FLASH memory. Preferably, the memory particularly useful in the present invention is volatile, or rewritable memory, designated as 16. A vehicle speed sensor, such as a road speed sensor or a wheel speed sensor 18 is electronically connected to the ECU and transmits data signals indicative of actual vehicle speed to the re-writable memory. As with all re-writable memory, as new data is received, old data signals may be overwritten. The system further includes a compass 20, electronically connected to the ECU to provide data signals indicative of vehicle direction or location to the rewritable memory in the buffer. At least one crash sensor 22, and preferably a multitude of crash sensors, is electronically connected to the ECU to transmit data signals indicative of crash situation that may exist in the vehicle operation. By way of example, but not to be construed as limiting, the crash sensors may include accelerometers, air bag actuation sensors, restraint condition sensors and any other sensor useful for the ECU to determine that a crash situation may exist. An optional Global Positioning System (GPS) may be electronically connected to the ECU to transmit data signals indicative of the vehicle location in real time to the ECU rewritable memory in the buffer. During normal operation of the vehicle, data signals as set forth above are constantly communicated to the ECU and stored and overwritten in the rewritable memory. A cellular telephone chip 26 capable of placing and receiving a telephone call to a local 911 emergency center is also provided. The cellular chip is activated by the ECU in the event a vehicle collision is detected, and initiates a direct telephone call 30 to a local PSAP/911 emergency call center 32, so that the telephone call from the cellular chip is detected by the PSAP/911 emergency call center as a high priority local telephone call. The PSAP/911 emergency call center may initiate a two way communication with the vehicle operator or occupants to assess the situation. The data signals stored in rewritable memory in the vehicle ECU buffer indicative of whether a vehicle crash condition exists are transmitted to the PSAP/911 emergency call center to permit the call center to transmit such information to the police or other emergency personnel in the event the operator or occupants are unresponsive to permit quick response to the perceived or actual vehicle collision. In another embodiment such information may be communicated directly to local police or other emergency personnel. Moreover, location may be understood by use of an e911 chip that transmits signals indicative of vehicle location.

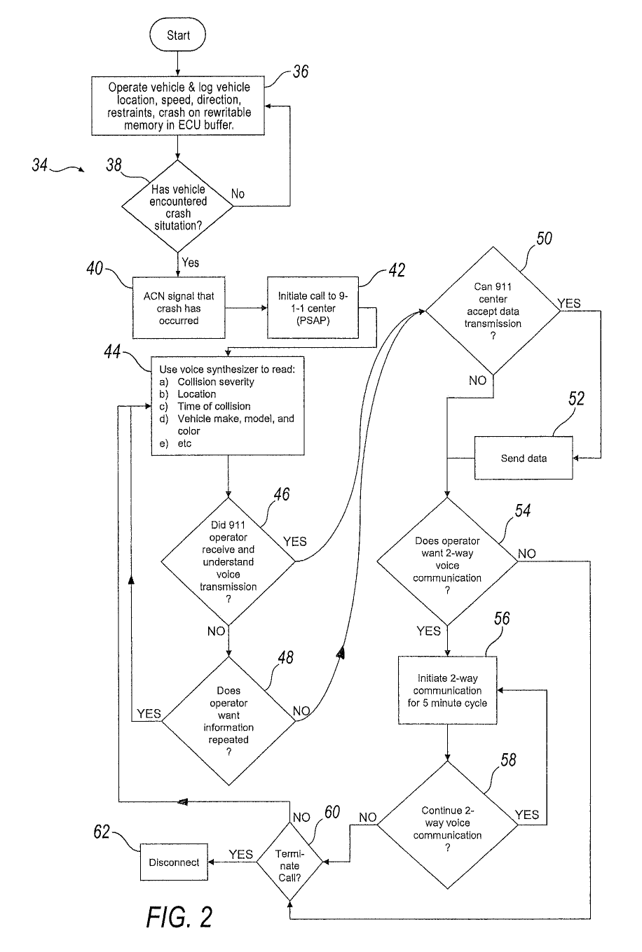

FIG. 2 is a software flow diagram of one method 34 that may be one embodiment of the present invention. Specifically, step 36 is operating the vehicle and logging vehicle location, speed, direction, vehicle occupant restraint condition, crash data, including pre-crash data on re-writable memory in the ECU buffer. Step 38 is determining whether the vehicle is encountering a crash situation. This may be determined by the ECU by comparing the data signals from the accelerometer, crash sensors, vehicle occupant sensors, etc., with values in memory to determine whether a crash or a pre-crash condition is being encountered. If it is determined that there is no crash or pre-crash condition, the software loops back to step 36. If it is determined that there is a crash or pre-crash condition, step 40 is a signal is generated that a crash has occurred. Step 42 is initiating a call to a PSAP/911 emergency call center as a native, local call to ensure the call receives top priority from the 911 emergency call center. Step 44 uses a voice synthesizer to read data from the ECU to the PSAP/911 emergency call center to permit the operator to assess the situation. The data may include collision severity, location of the collision, time of collision, vehicle make, model, color, year, etc., and any other data that may be determined to be useful to the operator of the PSAP/911 emergency call center to permit assessment of the situation. Step 46 is determining whether the 911 operator received and understood the voice transmission of data from the voice synthesizer of step 44. If no, step 48 is determining whether the operator wishes the information repeated. This may be activated by any voice activated system, where the operator answers yes or no in response to voice synthesizer request to answer whether the operator requires the information repeated. If the answer to step 48 is yes, the software loops back to step 44. If the answer to step 46 is yes, or, if the answer to step 48 is no, step 50 is determining whether the PSAP/911 emergency call center operator can accept data transmission. If yes, step 52 is transmit data. If no, step 54 is determining whether the operator requests 2-way voice communication. If no, step 60 is determining whether to terminate the call. If the determination in step 54 is yes, step 56 is initiating two way communication for a specific time cycle, preferably a 5 minute time cycle. Step 58 is determining whether to continue 2-way voice communication. If yes, the software loops back to step 56. If no, the software goes to step 60. As previously stated, step 60 is determining whether to terminate the telephone call to the PSAP/911 emergency call center. If no, the software loops back to step 44. If yes, the software goes to step 62, which is disconnect the telephone call.

While the invention has been described as set forth herein, it is understood that the words used are words of description, not words of limitation. Those skilled in the art recognize that many variations and modifications are possible without departing from the scope and spirit of the invention as set forth in the appended claims.

We claim:

1. A low cost, automatic, vehicle collision notification system, comprising:
an electronic controller with a buffer and memory wherein resides information related to vehicle direction, speed, and restraint conditions;
at least one vehicle crash sensor electronically connected to said electronic controller to produce data signals indicative of a vehicular crash;
at least one vehicle speed sensor electronically connected to said electronic controller to produce data signals indicative of actual vehicle speed; and
a cellular telephone chip electronically connected to said electronic controller; said chip configured to automatically communicate directly with a local PSAP/911 emergency call center as a native, local, high priority call when a vehicle crash is detected by said electronic controller; said cellular chip capable of transmitting information from said electronic controller buffer to said PSAP/911 emergency center to facilitate the dispatch of assistance to said vehicle.

2. The system of claim 1, wherein said electronic controller memory is re-writable.

3. The system of claim 1, wherein said vehicle crash sensor may be selected from at least one of an accelerometer, airbag sensor, a pressure sensor, a pre-crash sensor, an occupant sensor, a seat belt buckle sensor, and a restraint sensor.

4. The system of claim 1, further including a Global Positioning System or e911 embedded chip to provide additional location information to the electronic controller memory buffer for access by said cellular phone chip for transmission to a 911 emergency center.

5. The system of claim 1, wherein said cellular chip further including two way voice communication with said 911 emergency center over a speaker in the event a vehicle crash is detected.

6. The method of claim 1, wherein said information is comprised of vehicle location, crash sensor data, restraint sensor data, air bag sensor data, vehicle speed and direction of travel.

7. A method to facilitate a low cost, automatic vehicle collision notification to a PSAP/emergency 911 call center as a native, local high priority telephone call, comprising:
operating a vehicle with an electronic controller receiving data signals indicative of vehicle speed, vehicle direction, restraint condition and storing it on rewritable memory in a buffer;
determining whether said vehicle is in a crash situation;
transmitting a signal to a cellular chip indicative that said vehicle is in a crash;
initiating communication with a PSAP/911 emergency call center as a native, local, high priority.

8. The method of claim 7, further including transferring data from said electronic controller buffer to said PSAP/911 emergency call center.

9. The method of claim 8, wherein transferring data is automatic upon initiating said communication with said PSAP/911 emergency call center.

10. The method of claim 8, wherein transferring data is voice activated.

11. The method of claim 7, further including vehicle location on said rewritable memory in buffer.

12. The method of claim 7, wherein said data signal indicative of vehicle speed data signal is transmitted by a vehicle wheel sensor or road sensor.

13. The method of claim 7, wherein said data signal indicative of vehicle direction is transmitted to said electronic controller memory by a compass.

14. The method of claim 7, wherein determining whether the vehicle is in a crash situation included receiving data signals from sensors such as accelerometers, air bag sensors and vehicle restraint sensors.

15. The method of claim 7, wherein communication with said 911 emergency center includes a two way voice communication.

16. The method of claim 7, further including automatically notifying local police agencies that a vehicle crash situation may exist.

17. A method to facilitate a low cost, automatic vehicle collision notification to a PSAP/emergency 911 call center as a native, local high priority telephone call, comprising:
operating a vehicle with an electronic controller receiving data signals indicative of vehicle speed, vehicle direction, restraint condition and storing it on rewritable memory in a buffer;
determining whether said vehicle is in a crash situation;
transmitting a signal to a cellular chip indicative that said vehicle is in a crash;
initiating communication with a PSAP/911 emergency call center as a native, local, high priority call;
using a voice synthesizer to transmit information indicative of crash conditions to the PSAP/911 emergency call center;
determining whether the PAPS/911 emergency call center received and understood the information;
determining whether the PSAP/911 emergency center can accept data transmission of data signals indicative of crash conditions;
transmitting data signals indicative of crash conditions;
determining whether the operator desires two-way voice communication;
initiating two way communication for a predetermined period of time;
determine whether to continue two way communication beyond the predetermined period of time;
determining whether to terminate PSAP/911 emergency call center call disconnecting telephone communication after transmission of al information to the PSAP/911 emergency call center.

18. The method of claim 17, further including repeating the information to the PSAP/911 emergency call operator using the voice synthesizer.

19. The method of claim 17, wherein if the operator does not wish to have the information repeated, inquiry is made whether the PSAP/911 emergency call center may accept data transmission in lieu of voice communication.
